(19) United States
(12) Patent Application Publication
(10) Pub. No.: US 2011/0221962 A1
(43) Pub. Date: Sep. 15, 2011

(54) AUGMENTED REALITY VIA A SECONDARY CHANNEL

(75) Inventors: Moe Khosravy, Bellevue, WA (US); Katrika Marie Woodcock, Issaquah, WA (US)

(73) Assignee: Microsoft Corporation, Redmond, WA (US)

(21) Appl. No.: 12/816,523

(22) Filed: Jun. 16, 2010

Related U.S. Application Data
(60) Provisional application No. 61/312,362, filed on Mar. 10, 2010.

(51) Int. Cl. H04N 5/445

(52) U.S. Cl. 348/563; 348/E05.099

(57) ABSTRACT

Systems, and methods are provided for augmenting reality via a secondary channel. In some embodiments, a method can include: communicating a portion of live or pre-recorded content over a primary channel, communicating a portion of information corresponding to the portion of the content; and synchronizing the portion of the content and the portion of the information. The method can also include displaying the portion of the content and the portion of the information in a synchronized manner such that the portion of the content and the portion of the information have temporal correspondence or spatial correspondence with one another. The content can be social networking website data, television, film, video game, photo or any other data that can be rendered over a primary channel. The information can be comments, advertisements and/or product placement data associated with products displayed via the content.

### CROSS-REFERENCE TO RELATED APPLICATIONS

This application claims the benefit of U.S. Provisional Patent Application Ser. No. 61/312,362, filed Mar. 10, 2010, which is titled “Augmented Reality Via A Secondary Channel,” and the entire contents of which are incorporated herein by reference.

### TECHNICAL FIELD

The subject disclosure relates to providing information, and more specifically, to providing information corresponding to content on a primary channel.

### BACKGROUND

Currently, no cloud service or network storage provider has been able to effectively provide information as a service on any platform, with publishers, developers, and consumers all able to easily publish, specialize applications for and/or consume different types of data, in a way that can be tracked and/or audited for all involved and such that publishers can be guaranteed restrictions on their content can be enforced. If data can be published in such a manner, a variety of uses can be implemented based on the ubiquity of the consumption of that data anytime from any device. Conventional systems such as VH-1 “Pop-up Video,” which overlay information or otherwise integrate auxiliary information as part of the display of a primary channel, have certain limitations in that the correlation between the primary channel (e.g., a rock music video) and the auxiliary information (e.g., Pop-up information on top of the rock music video) is forever fixed, and tied to the display of the primary channel whenever displayed. In this sense, the auxiliary information is embedded or integrated with the primary content, and is thus a mere extension or augmentation of the primary channel content. Currently, there exist no systems that go beyond the ability to display statically defined information via a primary channel.

The above-described deficiencies of today's services are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of one or more of the exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In connection with information as a service from any platform, a primary channel providing content and a secondary channel providing information corresponding to the content can be output as a service to a consumer. The information can temporally or spatially correspond to the content, which can be live or previously-recorded film (e.g., movie) or television content, video, photos, video games or otherwise. The information can be product placement data for products provided as part of the content. For example, the content can display a designer shirt, jewelry on an actor and/or a video game being played by child actors that the consumer can then obtain information about via the secondary channel. The information can also be comments or advertisements or otherwise provided via the secondary channel to or from members of a social networking group. The secondary channel information can be provided during or after the time period during which the content is provided. Additionally, the primary channel and/or the secondary channel can be any type of media channel, including, but not limited to, a television channel, a music channel, a gaming channel, an internet channel or a video channel. As discussed above, conventional systems such as VH-1 “Pop-up Video,” overlay information or otherwise integrate auxiliary information as part of the display of a primary channel in a fixed fashion because the auxiliary or pop-up information is embedded or integrated with the primary channel content. By contrast, in the embodiments disclosed herein, the secondary channel can be a channel that is independent of the primary channel as the content of the secondary channel is not integrated within or statically-defined by the content of the primary channel as with conventional systems. Rather, the secondary channel can be flexibly, or dynamically, defined or the content of the secondary channel dynamically dictated, based on the current content of the primary channel. Similarly, in some embodiments, rather than a time-based synchronization, the content over the secondary channel can be spatially synchronized with the content over the primary channel such that the position of the content displayed from the secondary channel is related to the position of the content displayed on the primary channel, for example.

Additionally, in some embodiments, a secondary channel can stream film (e.g., movie) or any other type of high value content, including, but not limited to, audio, video games or television content. The content streamed over the secondary channel can be based at least in part on the information displayed on the primary channel. The content streamed over the secondary channel can be based at least in part on any number of factors, including, but not limited to, the demographics associated with the information on the primary channel and/or the preferences of a user viewing the primary channel. By way of example, but not limitation, in some embodiments, a war movie geared towards males between the ages of 21 and 25 can be streamed over the secondary channel based at least in part on the primary channel providing content geared towards males between the ages of 21 and 25. Similarly, country western music audio steams, for example, can be streamed over the secondary channel based at least in part on the primary channel providing content to a demographic located in a region of a country in which country western music is popular.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 is a block diagram illustrating an exemplary non-limiting infrastructure for information provided as a service from any platform;

FIG. 2 is a flow diagram illustrating an exemplary non-limiting embodiment for information provided as a service from any platform;

FIG. 3 is a block diagram of an exemplary non-limiting implementation of the infrastructure for information as a service as described above according to one or more features;

FIG. 4 is a block diagram illustrating an exemplary end to end flow from data to consumers of the data for enabling information as a service from any platform;

FIG. 5A is a block diagram illustrating an exemplary system for augmenting reality via a secondary channel for information as a service;

FIG. 5B is a block diagram illustrating another exemplary system for augmenting reality via a secondary channel for information as a service;

FIG. 6A is a flow diagram illustrating an exemplary method of augmenting reality via a secondary channel and employing spatial synchronization for providing information as a service on any platform;

FIG. 6B is another flow diagram illustrating an exemplary method of augmenting reality via a secondary channel and employing temporal synchronization for providing information as a service on any platform;

FIG. 7 is another flow diagram illustrating an exemplary method of augmenting reality via a secondary channel for providing information as a service on any platform;

FIG. 8 is another flow diagram illustrating an exemplary method of augmenting reality via a secondary channel for providing information as a service on any platform;

FIG. 9 is another flow diagram illustrating an exemplary method of augmenting reality via a secondary channel for providing information as a service on any platform;

FIG. 10 is a block diagram representing exemplary non-limiting networked environments in which various embodiments described herein can be implemented; and

FIG. 11 is a block diagram representing an exemplary non-limiting computing system or operating environment in which one or more aspects of various embodiments described herein can be implemented.

### DETAILED DESCRIPTION

The following description contains context regarding potential non-limiting infrastructure, architectures and/or associated services to further aid in understanding one or more of the above embodiments. Any one or more of any additional features described in this section can be accommodated in any one or more of the embodiments described above with respect to dynamically generating an end user license agreement. While such combinations of embodiments or features are possible, for the avoidance of doubt, no embodiments set forth in the subject disclosure should be considered limiting on any other embodiments described herein.

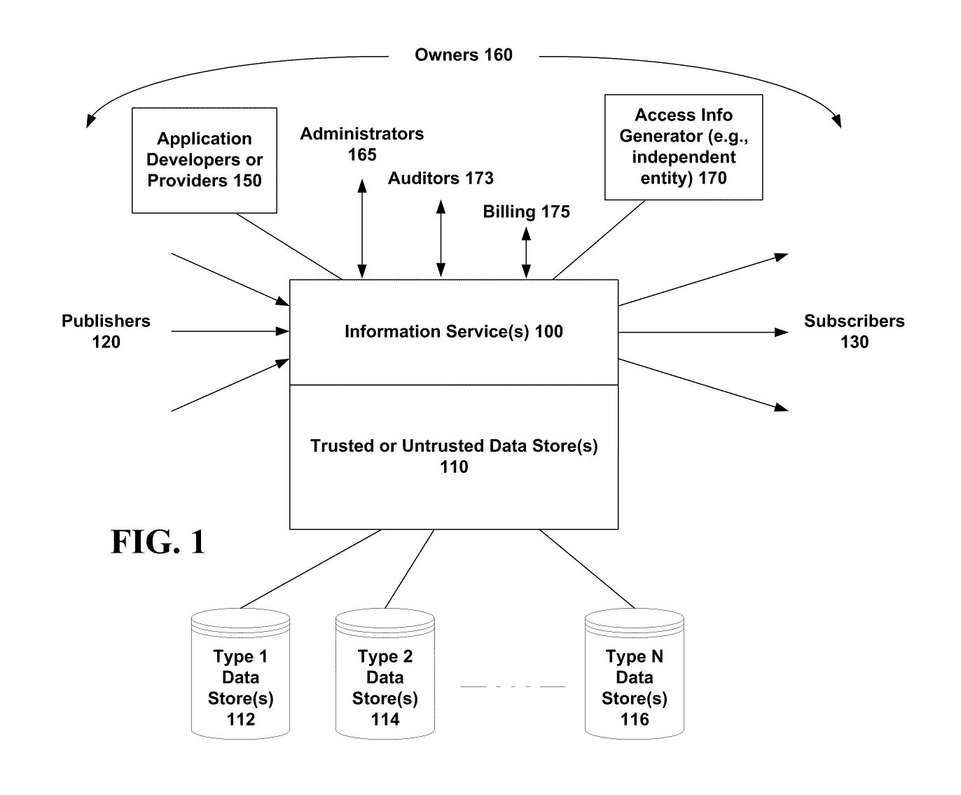

FIG. 1 is a block diagram illustrating an exemplary non-limiting set of implementation specific details for an infrastructure for information provided as a service from any platform. FIG. 1 generally illustrates the various parties that may participate in an ecosystem providing information as a service as described herein. For instance a set of network accessible information services 100 provide access to a variety of trusted or untrusted data stores 110, depending on the sensitivity or other characteristics of the data. As shown, thus, what type of data store, 112, 114, . . . , 116 is not so important since the ecosystem supports any kind of data, blob, structured, unstructured, etc. As mentioned, the system includes publishers 120 that add data to the ecosystem, subscribers 130 that consume the data and application developers or providers 150 who can consume the data with their applications. An access information generator 170 can also govern access to the data by various parties through maintaining or enforcing account information, key information, etc. In this respect, content owners 160 can span any of the roles in that a content owner 160 can be a publisher 120, a subscriber 130 and/or an application developer as well. In one aspect, the common infrastructure for all parties enables administration 165, auditing 173, billing 175 as well as other desired ancillary services to the data transactions occurring across the infrastructure.

In this regard, various embodiments for the user friendly data platform for enabling information as a service from any platform is an infrastructure to enable consumers of data (Information Workers (IWs), developers, independent software vendors (ISVs)) and consumers of data to transact in a simple, cost effective and convenient manner. The infrastructure democratizes premium (private) and community (public) data in an affordable way to allow IWs to draw insights rapidly, allows developers to build innovative apps using multiple sources of data in a creative manner and enables developers to monetize their efforts on any platform. For instance, the infrastructure supports Pay Per Use as well as Subscription Pricing for Content, Pay for Content (“retail price”—set by content owner), Pay Data Fee (“Shipping and Handling”), and further supports Data fees as a brokerage fee on a per-logical transaction basis (per report, per application program interface (API), per download, etc.).

For Information Workers (e.g., OFFICE®, SQL SERVER®, MICROSOFT DYNAMICS® users), the infrastructure supports subscriptions to allow for future enterprise architecture (EA) integration as well as predictable spend requirements (as well as caching to support on and off-premise Business Intelligence (BI) as well as high performance computing (HPC) workloads). Thus, alternatives include content priced per-user per-month; which may or may not bundle to deliver content packs or per-transaction pricing, e.g., allowing cloud reporting/business intelligence on-demand pricing to eliminate the need to move large amounts of data while allowing per-usage pricing, or vertical apps via report galleries.

For data owners (any data type; any cloud), using any platform, the infrastructure becomes a value proposition to incent sales within any particular desired platform; auto-scaling, higher level service level agreement (SLA) possibilities at no additional cost. For some non-limiting examples, data can be secure and associated data in the following domains: Location aware services & data, Commercial and residential real estate, Financial data and services, etc. A non-limiting scenario may include delivery of data to top 30 non-governmental organization (NGO) datasets. In addition, the infrastructure may include the ability to showcase BI & visualization through BING™ for information as a service, HPC, etc. Vertical application opportunities exist as well.

In one non-limiting embodiment, the data brokerage can be analogized to conventional brick and mortar strategies: For instance, capacity can be represented as shelf space (e.g., a mix of structured and unstructured/blob data), cost of goods (COGS) can be represented as square footage (e.g., platform dependency, bandwidth) and content can be represented as merchandise (e.g., optimize data owners to cover COGS, maximize profits from IWs and developers). In various embodiments, an onboarding process can be implemented with quality bars for data and services, as well as accommodation of service level agreements (SLAs).

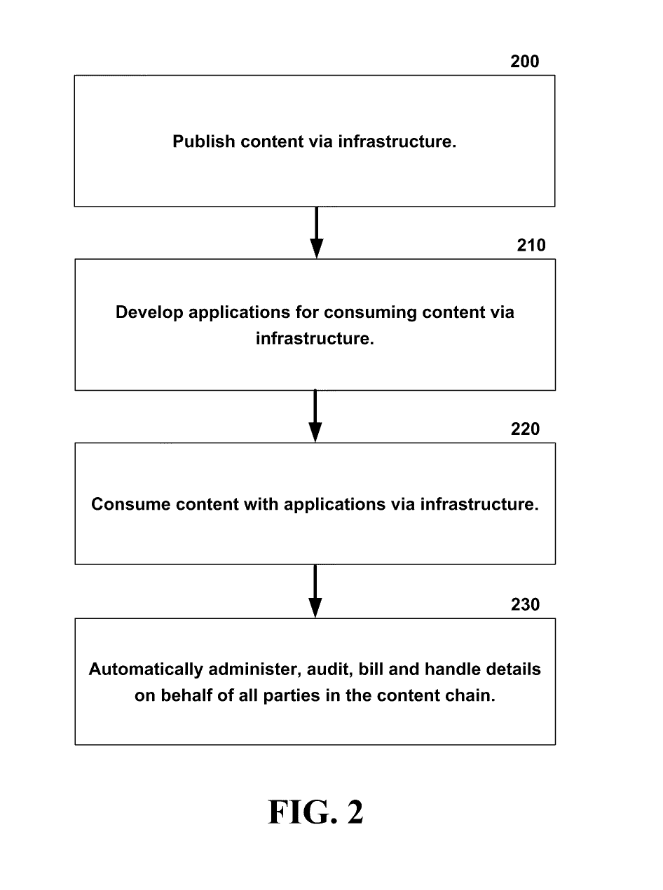

FIG. 2 is a flow diagram illustrating an exemplary non-limiting embodiment for information provided as a service from any platform. As shown in the flow diagram of FIG. 2, at 200, described herein are various ways for content owners or publishers to publish data via the infrastructure. At 210, there are a variety of tools that allow developers to develop applications for consuming the data via the infrastructure. At 220, consumers or information workers use the applications or can directly query over the data to consume the data. Lastly, the infrastructure provides a rich variety of tools at 230 that enable automatic administration, auditing, billing, etc. on behalf of all parties in the content chain, enabled by the transaction model.

In this regard, some key parties in the infrastructure include data owners, the application developers/ISVs and the consumers/information workers. In general, data owners are entities who want to charge for data, or who want to provide data for free for other reasons, or enforce other conditions over the data. In turn, application developers/ISVs are entities who want to monetize their application (e.g., through advertising, direct payments, indirect payments, etc.), or provide their application for free for some beneficial reason to such entities. Information workers and consumers are those who can use the raw data, or those who want to use an application provided by the application developers.

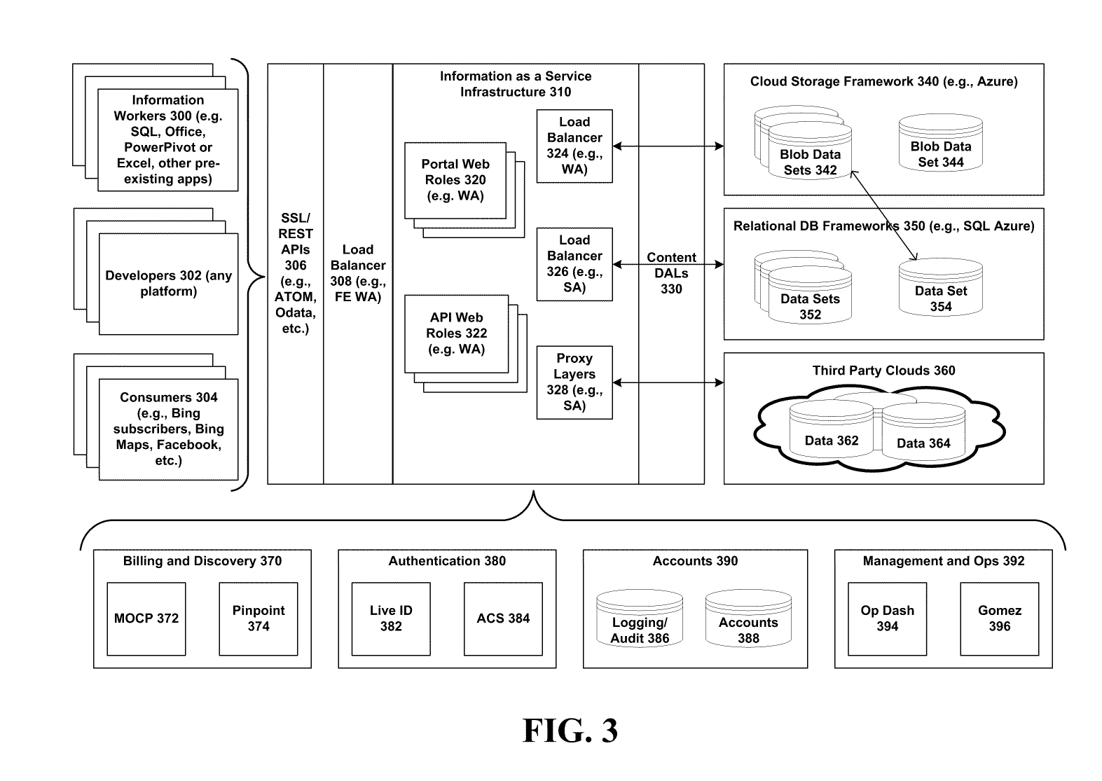

FIG. 3 is an exemplary non-limiting implementation of the infrastructure 310 for information as a service as described above according to one or more features. At the interaction side are information workers 300, developers 302 and consumers 304 who can communicate with the infrastructure via secure sockets layer (SSL)/representational state transfer (REST) based APIs 306. A load balancer 308 can be used to help steer traffic in an optimal way. In this regard, the input is routed to portal web roles 320 or API web roles 322. From the infrastructure 310 to the data side is additional load balancing 324 or 326 for access to blob data sets 342, or blob data set 355 of cloud storage framework 340, or to data sets 352 or data set 354 of relational database frameworks 350. Proxy layers 328 can be used to access data 362 or data 364 of third party clouds 360. Content data abstract layers (DALs) 330 can be used to access content, where applicable. In this regard, there can be duplication or overlap of data sets across different types of storage, e.g., the same data might be represented as blob data and as structured data, e.g., SQL SERVER®.

As supplemental services to the data, billing and discovery services 370 can include online billing 372 (e.g., MICROSOFT® Online Customer Portal (MOCP)) or discovery services 374 (e.g., pinpoint) and authentication services 380 can include credentials management 382 (e.g., MICROSOFT® Windows Live ID) or content authentication 384, e.g., authenticated content services (ACS). Accounts services 390 can include logging/audit services 386 or account management 388. Management and operations services 392 can include an operations dashboard service 394 and network operations service 396, e.g., Gomez.

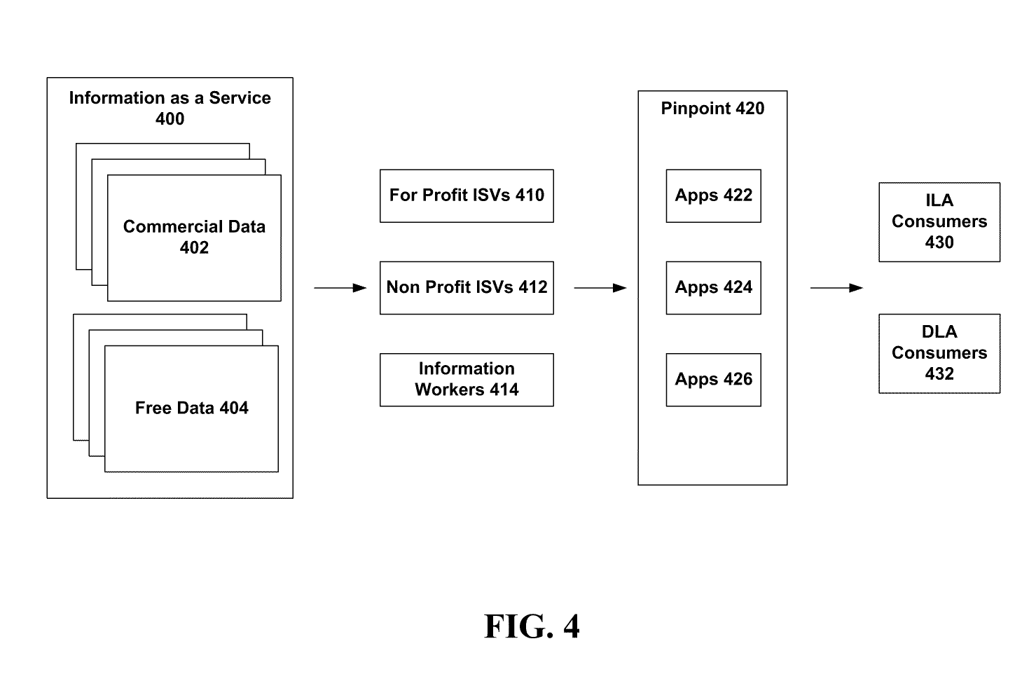

FIG. 4 is a block diagram illustrating an exemplary end to end flow from data to consumers of the data in accordance with one or more embodiments of the general infrastructure for enabling information as a service. For instance, information as a service 400 can include commercial data 402 and free data 404, which can be of interest to various for profit developers 410, nonprofit developers 412 with non-profit motives and other information workers 414 who are interested in consuming the data generally for productive goals. These entities can use discovery services 420 to determine what applications 422, 424, . . . , 426 may be of interest to them, and to ultimately transmit the data to indirect license acquisition (ILA) consumers 430 and direct license acquisition (DLA) consumers 432 alike.

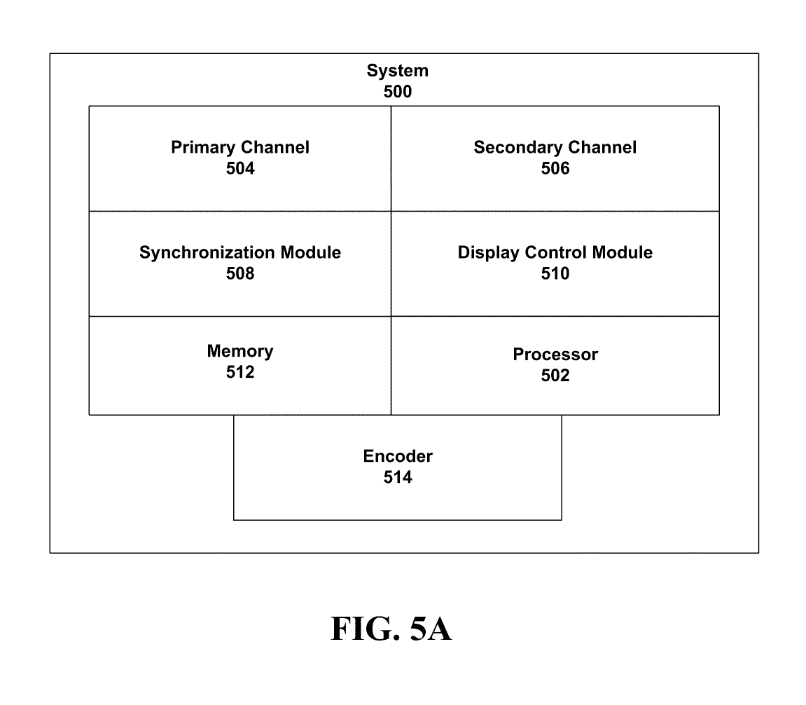

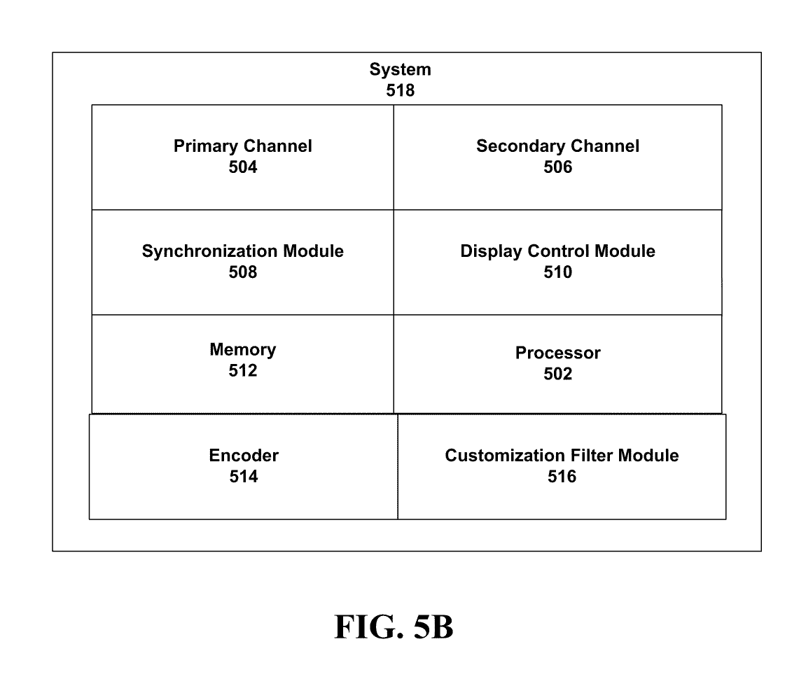

FIG. 5A is a block diagram of a system for augmenting reality via a secondary channel. The system 500 will be described with reference to FIGS. 1, 3, 4, 5A, 7 and 8. In some embodiments, the system 500 can be part of the information service 100.

The system can include a processor 502, a primary channel 504, a secondary channel 506, a synchronization module 508, a display control module 510, a memory 512 and an encoder 514.

With the ability to publish all kinds of information and consume such information anytime and from any platform, the secondary channel 506 of information can be defined for any primary channel 504 of content. The information on the secondary channel 506 can be consumed separately from the content on the primary channel 504. In some embodiments, such is a way for consumers of the primary channel 504 to be provided information for learning a variety of things about the content without disturbing the rendering of the content/primary channel. In some embodiments, such is a way for consumers of the primary channel 504 to be able to interact with the information on the secondary channel 506.

Additionally, the primary channel 504 and/or the secondary channel 506 can be any type of media channel, including, but not limited to, a television channel, a music channel, a gaming channel, an internet channel or a video channel.

The content can include, but is not limited to, a film (e.g., movie) television program, video, photo, social networking content, video game or website. In some embodiments, the content can be segmented into portions. By way of example, but not limitation, the content can be a television series and a portion of the content can be a product (e.g., apparel, automobile, food, business) displayed during the display of the television series.

The secondary channel 506 can be configured to communicate the information corresponding to the content. In some embodiments, the information corresponding to the content can be segmented into portions. For example, a portion of the information can be product placement data for a product displayed via the primary channel content. For example, the product can be jewelry that an actor is wearing on a television show, the video game child actors are playing on a television shown, the hours of operation and nearest location of a restaurant shown in the television show, a coupon for a product, a website associated with a product, or the like. The product placement data could be provided by the owner of the product as a form of advertisement in some embodiments.

In some embodiments, the product placement data can be tagged, either after the publication of content or as part of the publication process. In response to tagging, the secondary channel can obtain and output the product placement data on any platform.

In some embodiments, the information can be advertisements for products shown via the content and/or related to the products shown via the content. The advertisements can be based on the consumer demographic or preferences.

In some embodiments, the information is social networking information generated by one or more consumers. The social networking information can be generated by the one or more consumers while the system provides a portion of the content to the one or more consumers. For example, the social networking information can include one or more comments and/or advertisements about the portion of the content. The comments can be provided to or received from the secondary channel by members of a social networking group or member of a social networking website. In various embodiments, a community of feedback about the primary channel content can be published on the secondary channel for consumers to learn what other consumers are saying about content on the primary channel or information on the secondary channel. In this way, a virtual community can be formed in association with the content or information.

In one non-limiting embodiment, the feeds and information (e.g., social networking feeds from friends of a particular consumer) on a FACEBOOK® website or any other social networking website can be the content provided on the primary channel. The system can provide information corresponding to the content including, but not limited to, advertisements, offers and the like.

In some embodiments, the information can augment the content on a per consumer and/or per consumer network basis. In some embodiments, the information provided can be a function of a closeness that the consumer may indicate about a friend in the consumer network. As such, the consumer can receive an amount of information related to the friend's experience based, at least, upon a degree of closeness between the consumer and the friend.

In some embodiments, the consumer can receive an amount of information related to the consumer network based on the number of friends commenting on particular content. As the number of friends that comment on particular content increases, the amount of information corresponding to the content can increase.

In some embodiments, as the consumer shows interest in the information on the secondary channel by interacting with the information and/or by experiencing the primary channel content related to certain secondary channel information, additional information (e.g., advertisement) for the consumer or the consumer network can be provided tailored to the content of interest.

In lieu of or in addition to the aspects of the system described with reference to FIG. 5, in some embodiments, the secondary channel 506 can stream film (e.g., movie) or any other type of high value content, including, but not limited to, audio, video games or television content. The content streamed over the secondary channel 506 can be based at least in part on the information displayed on the primary channel 504. The content streamed over the secondary channel 506 can be based at least in part on any number of factors, including, but not limited to, the demographics associated with the information on the primary channel 504 and/or the preferences of a user viewing the primary channel 504. By way of example, but not limitation, in some embodiments, a war movie geared towards males between the ages of 21 and 25 can be streamed over the secondary channel 506 based at least in part on the primary channel 504 providing content geared towards males between the ages of 21 and 25. Similarly, country western music audio steams, for example, can be streamed over the secondary channel based at least in part on the primary channel providing content to a demographic located in a region of a country in which country western music is popular.

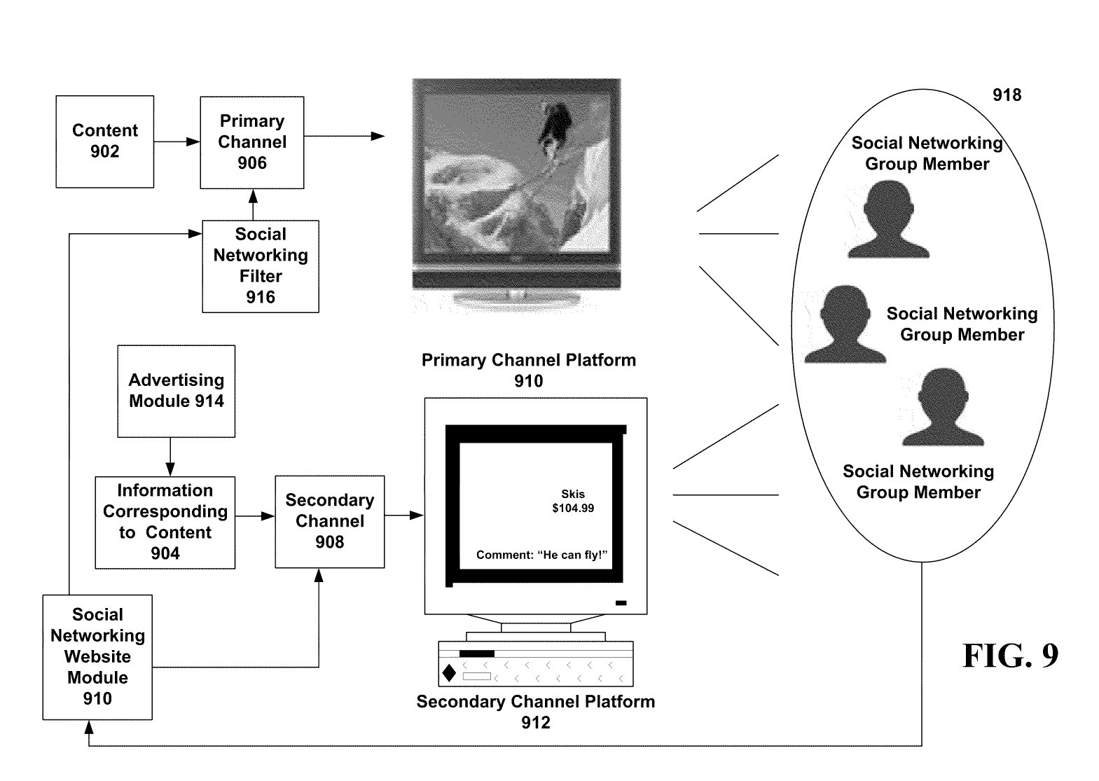

FIG. 9 is a block diagram illustrating one non-limiting embodiment of a system for corresponding to reality via a secondary channel and employing social networking The content 902 can be provided to the primary channel platform 910 via the primary channel 906.

The information corresponding to the content 904 can be provided to the secondary channel platform 912 via the secondary channel 908. In some embodiments, the portion of the content is data provided to a social networking group 918 and the portion of the information is a comment or an advertisement regarding the portion of the content.

The system can also include a social networking website module 910 configured to retrieve one or more comments from members of a social networking group 918. In some embodiments, the comments can be provided via any platform that is configured to receive textual or graphical inputs. The comment can be output from the social networking website module 910 to the secondary channel 908.

The system can also include a synchronization module (not shown) configured to synchronize the portion of the content and the portion of the information. The synchronization module can also synchronize a comment and/or advertisement with the content in various embodiments. The synchronization can be temporal or spatial as described variously herein.

For example, the synchronization module can be configured to provide a temporal correspondence between the comment and the advertisement such that the comment and the advertisement are displayable during overlapping time periods.

As another example, the synchronization module can be configured to provide a temporal correspondence between the comment and the advertisement such that the comment and the advertisement are displayable during non-concurrent time periods.

As another example, the synchronization module can be configured to provide a spatial correspondence between the comment and the content such that the comment is displayable in a position corresponding to a position at which the content is displayable.

In some embodiments, the system can also include a social networking filter 916 configured to generate a filter function. The filter function can be based, at least, on a comment received from a member of the social networking group 918. The social networking filter 916 can output the filter function to the primary channel 906 to control a modification of the content 902 by the primary channel. Accordingly, the primary channel 906 can tailor and modify the content 902 provided the members of the social networking group 918 according to the type or number of comments from the social networking group.

In some embodiments, the secondary channel 908 can be configured to communicate comments to one or more members of the social networking group 918. In some embodiments, in addition to the comments provided over the secondary channel 908, the secondary channel can be configured to provide or stream film (e.g., movies), television, audio or other high value content. The content provided or streamed on the secondary channel can be based at least in part on the content on the primary channel and/or the comments from the members of the social networking group 918.

In some embodiments, the primary channel 906 can be configured to modify the portion of the content and provide a new portion of content based, at least, in part, on the comment. For example, in some embodiments, the primary channel is configured to modify the portion of the content and provide a new portion of content based, at least, in part, on at least one of an identity of one or more members of the social networking group 918, a demographic of one or more members of the social networking group 918, a preference of one or more members of the social networking group 918 or a comment by one or more members of the social networking group 918.

In some embodiments, the system can also include an advertising module 914 configured to output advertisement to the secondary channel 908.

In some embodiments, the portion of the information can be customized based on a demographic of a consumer. For example, in embodiments wherein the information is provided automatically to a consumer viewing content on the primary channel, the portion of the information provided can be indicative of a demographic of the consumer. By way of example, but not limitation, consumers in suburbia can be provided information that tends to appeal to suburbanites. By way of another example, male consumers can be provided information about products that are displayed that tend to appeal to male consumers. By way of yet another example, female consumers can be provided information about products that are displayed that tend to appeal to female consumers.

In some embodiments, the portion of the information can be customized based on a preference of a consumer. In these embodiments, the consumer can provide one or more preferences for products or information generally. The preferences can be provided during the rendering of the content on the primary channel in some embodiments. In some embodiments, the preferences can be provided prior to or after the rendering of the content. By way of example, in some embodiments, the preferences can be pre-stored in a memory.

In some embodiments, the portion of the information can be tailored to the current conversation in which actors on the television program are engaged, the products being shown, the location within the script or the like. For example, different information can be transmitted on the secondary channel depending on whether the show is near concluding or has recently commenced, the topic of conversation or the like.

In one non-limiting embodiment, the platform on which the consumer is viewing the content can include a user interface able to receive inputs from the consumer. The consumer can provide an input letting the system know of interest by the consumer in obtaining additional information from the content. The system can receive the input and, knowing the identifier of content being displayed over the primary channel, the location in the content being displayed, and, in some cases, the language in which the content is presented, the system can know the content being displayed and provide information associated with the content that the consumer has tagged.

As a non-limiting example, the system can know that the television show House, episode 13 is being provided over the primary channel, the show is provided in English, and the current location is 10 minutes into the show. The location within the content can be specified in minutes, frames or any other manner enabling location of a frame being displayed. The system described herein can then receive such information, issue a call for relevant information corresponding to the content and transmit to a consumer, via the secondary channel, information that augments the content. In some embodiments, the system can search for relevant information using the OData protocol.

As another non-limiting example, if, on the television show House, the actor in the lead role, House, is holding a donut during a scene, such can be rendered on the primary channel. The donut can be an example of a portion of the content on the primary channel. If House is holding the donut, the secondary channel can display information corresponding to the donut. By way of example, but not limitation, the information corresponding to the donut can include a DUNKIN DONUTS® trademark, or other symbol associated with DUNKIN DONUTS®, and/or a variety of information about DUNKIN DONUTS® such as their hours, the nearest DUNKIN DONUTS® location to the consumer viewing the primary channel, etc.

In various embodiments, a consumer can interact with the information provided on the secondary channel to get more detailed information. For example, the consumer can enter commands and/or otherwise generate control signals for ascertaining more detailed information about, or different information other than, the information being displayed. By way of example, but not limitation, if information regarding store hours is being displayed, the consumer can interact with the information to determine the day for which the store hours are applicable and/or the location of the nearest store to the consumer.

In some embodiments, the control signal is initiated based, at least, upon the consumer tagging the portion of the content via a user interface accessible by the consumer. In some embodiments, displaying can then be performed based, at least, on receiving a control signal automatically generated based on at least one of a preference or demographic of a consumer to which the portion of the content is being displayed. In some embodiments, displaying comprises displaying the portion of the content on a first platform and displaying the portion of the information on a second platform. In some embodiments, displaying comprises displaying the portion of the content and the portion of the information on a same platform.

The first platform or the second platform can be at least one of a mobile device, television, video game console, camera, personal computer or laptop. In some embodiments, the platform can be at least one of a mobile device, television, video game console, camera, personal computer or laptop.

The secondary channel can be turned on or off and not affect the rendering provided by the primary channel. For example, the consumer can turn the secondary channel on upon viewing a product of interest on the primary channel.

The synchronization module 508 can be configured to provide a spatial correspondence between a portion of the content communicated on the primary channel and a portion of the information communicated on the secondary channel.

The display control module 510 can be configured to display the portion of the content and the portion of the information. The display can be based, at least, a control signal configured to control the display and/or on the correspondence between the content and the information.

In some embodiments, the display control module is configured to select the portion of the information for display based on the control signal. The control signal can be a signal received from a consumer viewing the portion of the content in some embodiments. In some embodiments, the control signal can be a signal initiated upon the consumer tagging a product (or photo, etc.) displayed as part of the portion of the content. In some embodiments, the control signal is a signal generated based on a preference of a consumer experiencing the portion of the content. Accordingly, as described above, the control signal and control generally generating the information corresponding to the content can be automatically or manually initiated.

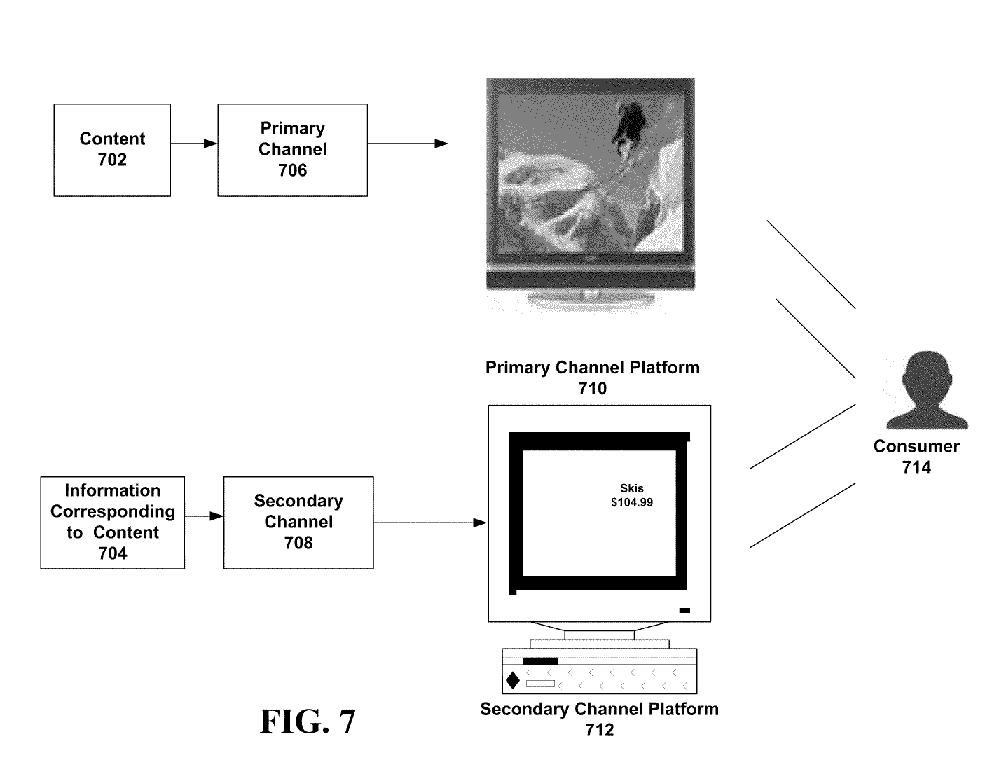

In some embodiments, the correspondence is a spatial correspondence and the synchronization module and display control module are configured such that the portion of the information corresponding to the portion of the content is displayed in a position corresponding to a position of the portion of the content. For example, as shown in FIG. 7, content 702 can be provided via primary channel 706 to primary channel platform 710, which is being watched by consumer 714. The content can include a scene including snow-covered mountains, skis, a helmet and a ski jacket. The skis can be provided in the upper right hand corner of the screen of the primary channel platform 710. Information corresponding to the ski content 704 can be provided via the secondary channel 708 to the secondary channel platform 712, which is also accessible to the consumer 714. The information can be provided such that it corresponds to the position of the skis. For example, information such as the cost of the skis can be provided in the upper right hand corner of the secondary channel platform 712. In various embodiments, the content 702 and information corresponding to the content 704 can be provided during overlapping or non-overlapping time periods according to the temporal correspondence provided by the synchronization module (not shown). While the primary channel 706 has been discussed as a television channel in the above embodiment, in general, in various embodiments, the primary channel 706 and/or the secondary channel 708 can be any type of channel configured to communicate media including, but not limited to, music channels, video channels, gaming channels and internet channels.

Referring to FIGS. 5A and 7, in some embodiments, the correspondence is a temporal correspondence and the display control module is configured to display the portion of the content and the portion of the information corresponding to the portion of the content during concurrent time periods.

For example, in one embodiment, the secondary channel information corresponds in time to the content provided on the primary channel, notwithstanding the content may or may not be live content. For example, the content may be and previously-recorded. Nonetheless, the information displayed on the secondary channel can correspond in time with the content (even if the content displayed is displayed days or weeks after the content was recorded). Accordingly, embodiments described herein can communicate information over the secondary channel that corresponds in time with the content being displayed via the primary channel even when the content on the primary channel is not live.

In some embodiments, the correspondence is a temporal correspondence and the synchronization module and display control module are configured such that the time period for which the information augments the portion of the content is synchronized to overlap with the time period during which the portion of the content is displayed. The synchronization with the content can be provided notwithstanding a consumer may rewind, fast forward or skip portions of content or commercials that may be provided on the primary channel.

In various embodiments, temporal correspondence can be maintained by a back end communicatively coupled to or within the system. For example, with a digital video recorder, when a consumer viewing the primary channel content causes a pause or rewind or fast forward to occur, the secondary channel can output corresponding information corresponding to the content being displayed in view of the pause, rewind, fast forward, skip or other operation because a back end can maintain time information about the information corresponding to the content such that the information corresponding to the content can be associated with the current content. The back end can provide the time information to the secondary channel in some embodiments, and the secondary channel can select the appropriate information for output. In some embodiments, the back end can provide the appropriate information to the secondary channel for output.

In some embodiments, the correspondence is a temporal correspondence and the synchronization module and display control module are configured such that the time period during which the information corresponding to the content is displayed is non-overlapping with the time period during which the portion of the content is displayed. As such, the information can augment content that has already been displayed. In various embodiments, the information corresponding to the content can be cached for later viewing after the display of the content display has ended.

The primary channel content and the second channel information can be displayed on the same platform or on two or more different platforms. For example, the content can be displayed on a first platform and the information can be displayed on a second platform. The platform can be a digital video recorder (DVR), laptop, personal computer (PC), mobile device, set top box, television, video game console (e.g., Xbox) or any other device capable of rendering content and/or information corresponding to the content.

In some embodiments, the temporal correspondence comprises a display of the portion of the content and a display of the portion of the information being during concurrent time periods. In some embodiments, the temporal correspondence comprises a display of the portion of the content and a display of the portion of the information being during non-overlapping time periods.

In some embodiments, displaying is performed based, at least, on receiving a control signal initiated manually by a consumer to which the portion of the content is being displayed.

In some embodiments, displaying is performed based, at least, on receiving a control signal automatically generated based on at least one of a preference or demographic of a consumer to which the portion of the content is being displayed.

In some embodiments, displaying comprises displaying the portion of the content on a first platform and displaying the portion of the information on a second platform. The first platform or the second platform can be at least one of a mobile device, television, video game console, camera, personal computer or laptop.

In some embodiments, displaying comprises displaying the portion of the content and the portion of the information on a same platform. The platform can be at least one of a mobile device, television, video game console, camera, personal computer or laptop.

In some embodiments, the portion of the information is social networking information generated by one or more consumers experiencing the portion of the content. In some embodiments, the social networking information is generated by one or more consumers experiencing the portion of the content. In some embodiments, the social networking information comprises one or more comments or advertisements associated with the portion of the content.

In some embodiments, the control signal is initiated based, at least, upon the consumer tagging the portion of the content via a user interface accessible by the consumer.

In various embodiments, at least one of the primary channel or the secondary channel is a music channel. In some embodiments, at least one of the primary channel or the secondary channel is a gaming channel.

In lieu of or in addition to the aspects of the system described above, in some embodiments, the secondary channel can stream film (e.g., movie) or any other type of high value content, including, but not limited to, audio, video games or television content. The content streamed over the secondary channel can be based at least in part on the information displayed on the primary channel and can have temporal and/or spatial correspondence to the information on the primary channel. By way of example, but not limitation, in some embodiments, a war movie geared towards males between the ages of 21 and 25 can be streamed over the secondary channel based at least in part on the primary channel providing content geared towards males between the ages of 21 and 25. Further, in cases wherein the content can be visually displayed, the content on the secondary channel can be displayed in spatial correspondence to the information on the primary channel. Similarly, any content displayed on the secondary channel can be displayed in temporal correspondence to the content on the primary channel. By way of example, but not limitation, audio can be streamed over the secondary channel in temporal correspondence to the content on the primary channel. For example, country western music audio steams, for example, can be streamed over the secondary channel over a time interval during which selected television programming is provided over the primary channel providing content to a demographic located in a region of a country in which country western music is popular. When the programming is no longer provided to such portion of the country, the system can cease streaming the country western audio over the secondary channel.

In other embodiments, a computer-implemented system (not shown) is provided. The computer-implemented system can include: at least one processor; a primary channel configured to communicate a portion of content; and a secondary channel configured to communicate a portion of information corresponding to the content. The computer-implemented system can also include at least one customization filter module configured to receive the portion of information and filter the portion of information according to a preference of a consumer to which the primary channel is configured to provide the portion of the content; and at least one synchronization module configured to synchronize the portion of the content and a filtered portion of the information. The computer-implemented system can also include a display control module configured to control a display the portion of the content and the filtered portion of the information in a synchronized manner controlled by the synchronization module; and a computer-readable storage medium storing computer-executable instructions that, when executed, cause the at least one processor to perform one or more functions of the primary channel, the secondary channel, the at least one customization filter, the at least one synchronization module or the display control module.

In some embodiments, the preference of the consumer is based, at least, on a demographic of a consumer. In some embodiments, the demographic of the consumer comprises at least one of a gender of the consumer or an age of the consumer. In some embodiments, the demographic of the consumer is a female less than 25 and the portion of the information comprises a sports car and a tool set and the filtered portion of the information consists of the sports car.

In some embodiments, the preference of the consumer is based, at least, on a selection of one or more options by a consumer.

In some embodiments, at least one of the primary channel or the secondary channel is a music channel. In some embodiments, at least one of the primary channel or the secondary channel is a gaming channel.

In other embodiments, another computer-implemented system (not shown) is provided. The computer-implemented system can include: at least one processor; a secondary channel configured to communicate information corresponding to content; and an advertising engine/bid processor. The advertising engine/bid processor can be configured to: receive one or more bids for placement of advertisement on the secondary channel; and output to the secondary channel, the information corresponding to content, wherein the information corresponding to content comprises advertisement selected by the advertising engine/bid processor. The computer-implemented system can also include: a computer-readable storage medium storing computer-executable instructions that, when executed, cause the at least one processor to perform one or more functions of the secondary channel or the advertising engine/bid processor.

In some embodiments, the advertisement selected by the advertising engine/bid processor is associated with a one of the one or more bids that is above a threshold. In some embodiments, the threshold is based, at least, on the content.

In some embodiments, at least one of the primary channel or the secondary channel is a music channel. In some embodiments, at least one of the primary channel or the secondary channel is a gaming channel.

In still other embodiments, another computer-implemented system (not shown) is provided. The computer-implemented system can include: at least one processor; a primary channel configured to communicate a portion of content; and a secondary channel configured to communicate a portion of information corresponding to the content, wherein the portion of the content is data provided to a social networking group and the portion of the information is at least one of a comment or an advertisement regarding the portion of the content. The computer-implemented system can also include: a social networking module configured to retrieve the comment and output the comment to the secondary channel; at least one synchronization module configured to synchronize the portion of the content and the portion of the information; and a display control module configured to control a display the portion of the content and the portion of the information in a synchronized manner controlled by the synchronization module. The computer-implemented system can also include a computer-readable storage medium storing computer-executable instructions that, when executed, cause the at least one processor to perform one or more functions of the primary channel, the secondary channel, the at least one synchronization module or the display control module.

In some embodiments, the comment is provided by a member of the social networking group. In some embodiments, the secondary channel is configured to communicate the comment to one or more members of the social networking group. In some embodiments, the primary channel is configured to modify the portion of the content and provide a new portion of content based, at least, in part, on the comment.

In some embodiments, the primary channel is configured to modify the portion of the content and provide a new portion of content based, at least, in part, on at least one of an identity of one or more members of the social networking group, a demographic of one or more members of the social networking group, a preference of one or more members of the social networking group or a comment by one or more members of the social networking group.

In some embodiments, the computer-implemented system can also include an advertising module configured to output the advertisement to the secondary channel.

In some embodiments, the synchronization module is further configured to provide a temporal correspondence between the comment and the advertisement such that the comment and the advertisement are displayable during overlapping time periods. In some embodiments, the synchronization module is further configured to provide a temporal correspondence between the comment and the advertisement such that the comment and the advertisement are displayable during non-concurrent time periods. In some embodiments, the synchronization module is further configured to provide a spatial correspondence between the comment and the content such that the comment is displayable in a position corresponding to a position at which the content is displayable.

In some embodiments, the computer-implemented system can also include: a social networking filter configured to generate a filter function based, at least, on the comment and output the filter function to the primary channel to control a modification of the content.

In some embodiments, at least one of the primary channel or the secondary channel is a music channel. In some embodiments, at least one of the primary channel or the secondary channel is a gaming channel.

In some embodiments, to display the information on the content on the same platform. For example, the content and the information can be published together. In some embodiments, an encoder 514 can be provided with the system 500. The encoder 514 can be configured to encode the portion of the content and the portion of the information such that the portion of the content and the portion of the information are concurrently displayable on the same platform. A decoder (not shown) can decode the signal that includes the encoded content and information.

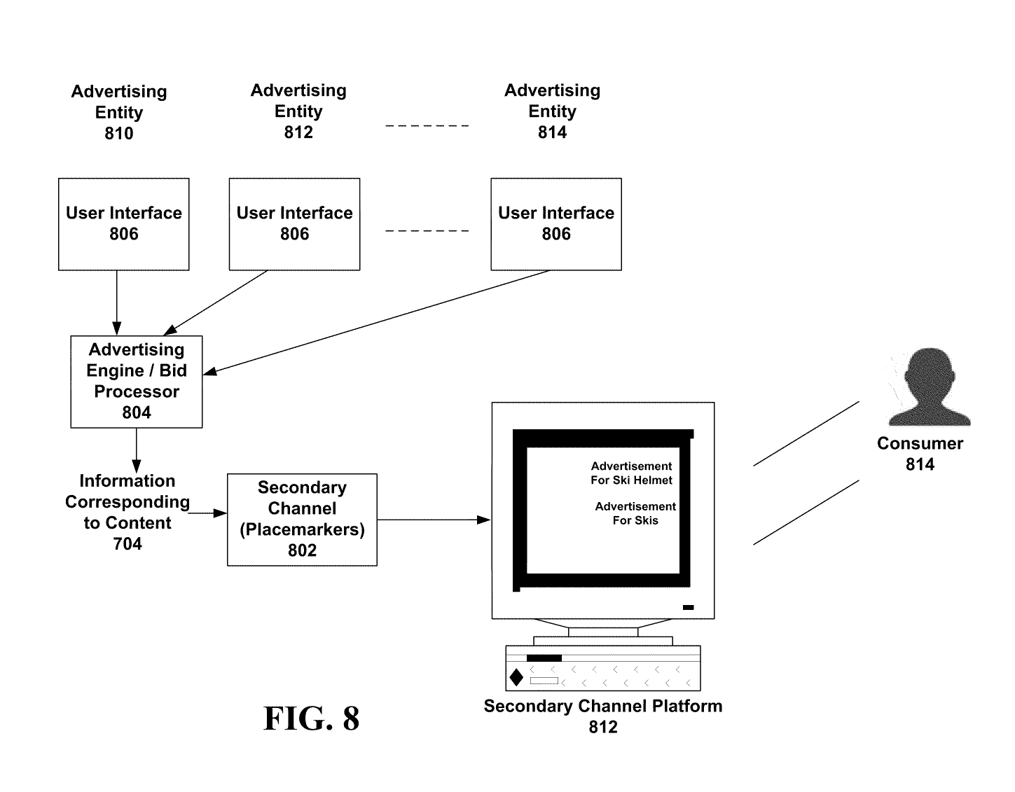

FIG. 8 is another block diagram of an exemplary embodiment of corresponding to reality via a secondary channel. In various embodiments, the secondary channel 802 can be or include nothing more than mere placemarkers for advertisements that are input into an advertising engine/bid processor 804 communicatively coupled to the secondary channel 802. Advertisers can bid on the placemarkers for placement of advertisements associated with products offered by the advertisements. As such, the information corresponding to the content in FIG. 7 can be output from the advertising engine/bid processor 804. In some embodiments, a user interface can be communicatively coupled to the advertising engine for receiving bids from one or more advertisers. The consumer 814 can view the advertisements selected by the advertising engine/bid processor 804 on the secondary channel platform 812.

Referring to FIGS. 5A, 7 and 8, the system can also include a memory 512. The memory 512 can include computer-executable instructions that, when executed, cause the processor 502 to perform one or more of the functions for corresponding to reality via a secondary channel.

FIG. 5B is a block diagram illustrating another exemplary system for corresponding to reality via a secondary channel for information as a service. The system 518 will be described with reference to FIGS. 1, 3, 4, 5A and 5B. In some embodiments, the system 518 can be part of the information service 100.

The system can include a processor 502, a primary channel 504, a secondary channel 506, a synchronization module 508, a display control module 510, a memory 512, an encoder and/or a customization filter module 516.

In some embodiments, one or more aspects of the system 518, processor 502, a primary channel 504, a secondary channel 506, a synchronization module 508, a display control module 510, and/or a memory 512 can be as described above with regard to FIG. 5A. However, system 518 can also include the customization filter module 516.

The customization filter module 516 can be configured to receive the portion of information and filter the portion of information. The synchronization module 508 can be configured to synchronize the portion of the content and the filtered portion of the information received from the customization filter module 516 according to a temporal correspondence between the portion of the content and the portion of the information (or the filtered portion of the information). Accordingly, the display control module 510 can be configured to control a display the portion of the content and the filtered portion of the information in a synchronized manner controlled by the synchronization module 508.

The filtering can be according to a preference of a consumer to which the primary channel is configured to provide the portion of the content.

In some embodiments, the preference of the consumer can be based on a demographic of a consumer. For example, the demographic can include a gender of the consumer or an age of the consumer. As one non-limiting example, the customization filter module 516 can filter out a portion of information typically associated with a male consumer if a female consumer is provided the primary channel content. For example, for the demographic of females less than 25, if the portion of the information includes a sports car and a tool set, the customization filter module can be configured to filter out the tool set and provide only information related to the sports car on the secondary channel.

In some embodiments, a consumer can select one or more options (or a subset of a set of options) indicative of the preferences. The consumer can select the options during or prior to the provisioning of the content on the primary channel in some embodiments.

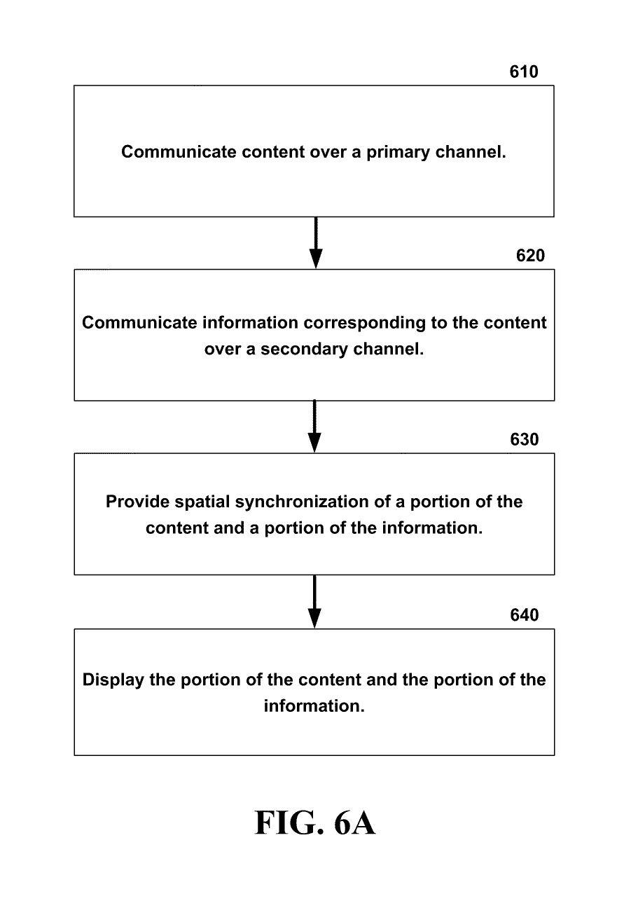

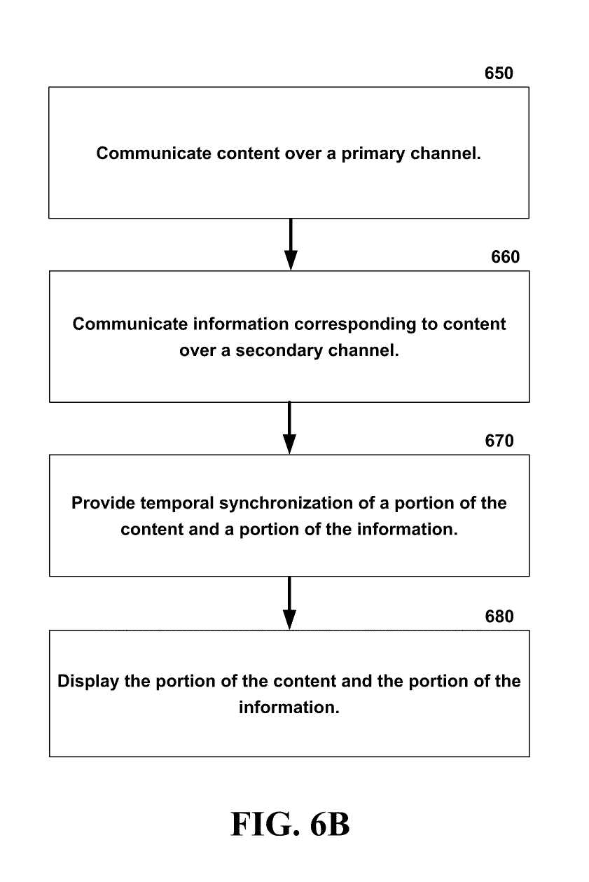

FIG. 6A is a flow diagram illustrating an exemplary method of corresponding to reality via a secondary channel and employing spatial synchronization for providing information as a service on any platform.

At 610, the method can include communicating content over a primary channel. The content can be a film (e.g., movie), a television program, video, photo, social networking content, a video game or website or any other content displayable over a channel.

In some embodiments, the content can be segmented into portions. For example, a portion of the content can be a product displayed via the content. By way of example, but not limitation, the content can be television program and a portion of the content can be a product (e.g., apparel, automobile, food, business) displayed during the display of the television program.

At 620, the method can include communicating, over a secondary channel, information corresponding to the content. The information can include product placement data, advertisements, comments about the content or the like. In some embodiments, the information is social networking information generated by one or more consumers experiencing the portion of the content. The social networking information can include one or more comments or advertisements about the portion of the content. The comments can be received from or provided to the secondary channel by one or more members of a social network. In some embodiments, the information corresponding to the content can be segmented into portions of information corresponding to portions of content.

In some embodiments, a portion of the information is social networking information generated by one or more consumers experiencing the portion of the content. The social networking information can comprise one or more comments or advertisements associated with the portion of the content.

Accordingly, the primary channel and/or the secondary channel can be any of a number of different types of media channels including, but not limited to, television, video, music, internet or gaming channels.

At 630, the method can include providing spatial synchronization of a portion of the content communicated on the primary channel and a portion of the information communicated on the secondary channel. In some embodiments, the spatial synchronization results in spatial correspondence and the portion of the information is displayed with positional correspondence to the position of the portion of the content.

For example, the portion of the information can be displayed in a region or quadrant of a first screen. And the region or quadrant can correspond to the region or quadrant in which the portion of the information is displayed on (either on the same, first screen, or on a different, second screen). In some embodiments, the first screen and the second screen are associated with different platforms.

In some embodiments, the spatial correspondence comprises a display of the portion of the content in a first quadrant of a first screen, and a display of the portion of the information in a second quadrant of a second screen. The first quadrant and the second quadrant can be the same quadrant in some embodiments.

In one non-limiting embodiment, spatial correspondence can include displaying information corresponding to content at a location on a screen displaying the primary channel in a manner such that the information corresponding to the content is displayed near the content. For example, spatial correspondence can include displaying, near the bottom of the screen, information corresponding to shoes displayed at the bottom of the television or mobile device. As another example, spatial correspondence can include displaying, near the upper left corner of a screen, information corresponding to a donut if the donut is displayed near the upper left corner of the screen.

In general, spatial correspondence can include displaying the information corresponding to the content within a close proximity to the content. For example, close proximity can be determined based on the screen size. In some embodiment, close proximity can be based, at least, on the screen size. On a television screen, close proximity can place the information within inches of the content, on a mobile device, close proximity can place the information within millimeters of the content. In some embodiments, the close proximity can be a ratio of the screen size, and the ratio can be the same for any screen size.

In some embodiments, a user interface can pan to determine whether a product has been tagged. If a determination is made that a product has been tagged, the system can obtain the quadrant or other location information indicative of the location of the content that is tagged. As such, this approach can locate and determine a position regardless of the format of the screen (e.g., widescreen, standard screen, mobile device screen). For a frame during which products are shown, the consumer can, as part of the publication experience, manually or through image processing, tag the products using the user interface accessible by the consumer. Based on the television show identity, location within the show and communication between the system and the device on which the user is viewing the content, scaling can be performed to place the information corresponding to the tagged product, by placing the content and information in relation to one another, no matter the form factor of the device on which the consumer is viewing the content.

At 640, the method can include displaying the portion of the content and the portion of the information. The display can be based, at least, on the synchronization. The displaying can be on different platforms in some embodiments.

The displaying can be on the same platform in some embodiments. In some embodiments, an encoder can encode the content and the information such that it can be displayed on the same platform. In some embodiments, the content and information can be encoded together during the publication process.

The displaying can be controlled based on a control signal. In some embodiments, the control signal can be initiated by a consumer viewing the content. For example, the consumer can tag a product via a user interface and the tagging can generate the control signal. As such, the control signal can be manually generated.

In some embodiments, the control signal can be automatically generated. For example, the control signal can be generated based on the consumer preference and/or the consumer demographic and/or a social network to which the consumer is associated.

FIG. 6B is another flow diagram illustrating an exemplary method of corresponding to reality via a secondary channel and employing temporal synchronization for providing information as a service on any platform.

At 650, the method can include communicating content over a primary channel. The content can be a film, a television program, video, photo, social networking content, a video game or website or any other content displayable over a channel.

In some embodiments, the content can be segmented into portions. For example, a portion of the content can be a product displayed via the content. By way of example, but not limitation, the content can be television program and a portion of the content can be a product (e.g., apparel, automobile, food, business) displayed during the display of the television program.

At 660, the method can include communicating, over a secondary channel, information corresponding to the content. The information can include product placement data, advertisements, comments about the content or the like. In some embodiments, the information is social networking information generated by one or more consumers experiencing the portion of the content. The social networking information can include one or more comments or advertisements about the portion of the content. The comments can be received from or provided to the secondary channel by one or more members of a social network. In some embodiments, the information corresponding to the content can be segmented into portions of information corresponding to portions of content.

Accordingly, the primary channel and/or the secondary channel can be any of a number of different types of media channels including, but not limited to, television, video, music, internet or gaming channels.

At 670, the method can include providing temporal synchronization of a portion of the content communicated on the primary channel and a portion of the information communicated on the secondary channel. In some embodiments, the temporal synchronization results in temporal correspondence and the portion of the information is displayed in a temporal relationship with the portion of the content.

In general, the information on the secondary channel can be linked to the primary channel content for the temporal correspondence. In one non-limiting embodiment, again using the example of the television show, House, if the lead role, House, is holding a donut during a scene, the donut information can be displayed on the secondary channel only as long as the donut is displayed on the primary channel. Temporal correspondence can further allow the secondary channel to mimic the fast forwarding, skipping or rewinding of the content on the primary channel.

In some embodiments, the temporal correspondence and associated displaying can include displaying the portion of the content and the portion of the information during concurrent time periods. The synchronization can enable such display, in some embodiments, notwithstanding the content or portion of the content is caused to rewind, fast forward or skip content.

In some embodiments, the temporal correspondence and associated displaying comprises displaying the portion of the information content and the portion of the information during non-overlapping time periods. As such, live or previously-recorded content can be provided to a consumer and information corresponding to the content can be provided to a consumer at a later time and/or after the content display has ended.

At 680, the method can include displaying the portion of the content and the portion of the information. The display can be based, at least, on the synchronization. The displaying can be on different platforms in some embodiments.

The displaying can be on the same platform in some embodiments. In some embodiments, an encoder can encode the content and the information such that it can be displayed on the same platform. In some embodiments, the content and information can be encoded together during the publication process.

The displaying can be controlled based on a control signal. In some embodiments, the control signal can be initiated by a consumer viewing the content. For example, the consumer can tag a product via a user interface and the tagging can generate the control signal. As such, the control signal can be manually generated.

In some embodiments, the control signal can be automatically generated. For example, the control signal can be generated based on the consumer preference and/or the consumer demographic and/or a social network to which the consumer is associated.

### Exemplary Networked and Distributed Environments

One of ordinary skill in the art can appreciate that the various embodiments of methods and devices for augmenting reality via a secondary channel as described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

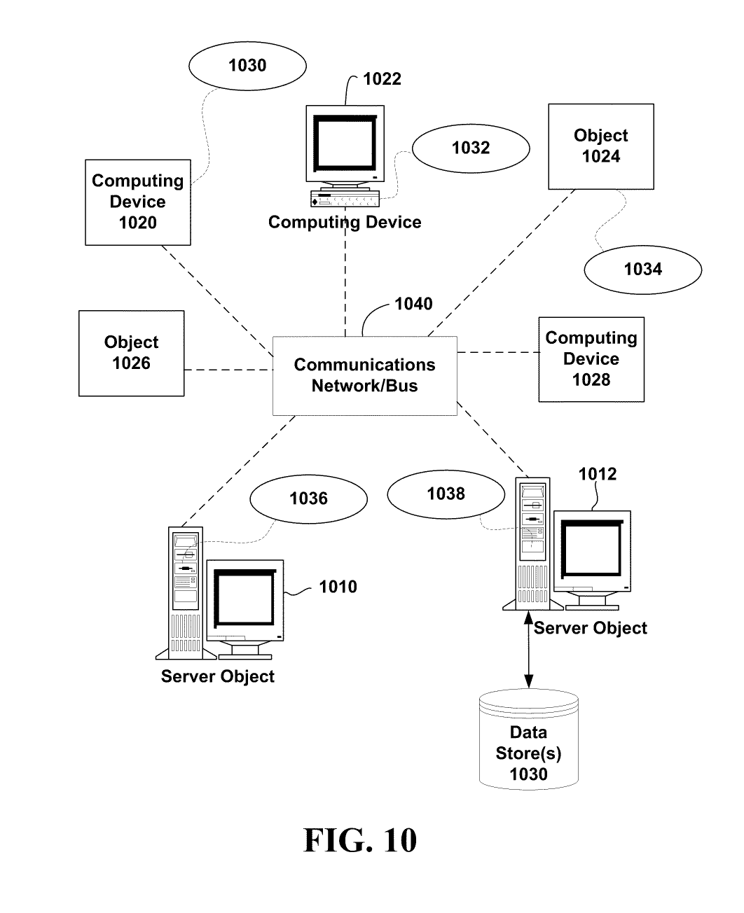

FIG. 10 provides a non-limiting schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038. It can be appreciated that objects 1010, 1012, etc. and computing objects or devices 1020, 1022, 1024, 1026, 1028, etc. may comprise different devices, such as personal digital assistants (PDAs), digital video disks (dvds), compact discs (cds), audio/video devices, mobile phones, MP3 players, laptops, etc.

Each object 1010, 1012, etc. and computing objects or devices 1020, 1022, 1024, 1026, 1028, etc. can communicate with one or more other objects 1010, 1012, etc. and computing objects or devices 1020, 1022, 1024, 1026, 1028, etc. by way of the communications network 1040, either directly or indirectly. Even though illustrated as a single element in FIG. 10, network 1040 may comprise other computing objects and computing devices that provide services to the system of FIG. 10, and/or may represent multiple interconnected networks, which are not shown. Each object 1010, 1012, etc. or computing objects or devices 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of an infrastructure for information as a service from any platform as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and objects 1010, 1012, etc. can be thought of as servers where servers, etc. provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances. Any of these computing devices may be processing data, or requesting services or tasks that may implicate an infrastructure for information as a service from any platform and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 1040 is the Internet, for example, the servers etc. can be Web servers with which the client computing objects or devices 1020, 1022, 1024, 1026, 1028, etc. communicate via any of a number of known protocols, such as hypertext transfer protocol (HTTP). Servers etc. may also serve as client computing objects or devices 1020, 1022, 1024, 1026, 1028, etc., as may be characteristic of a distributed computing environment.

### Exemplary Computing Device

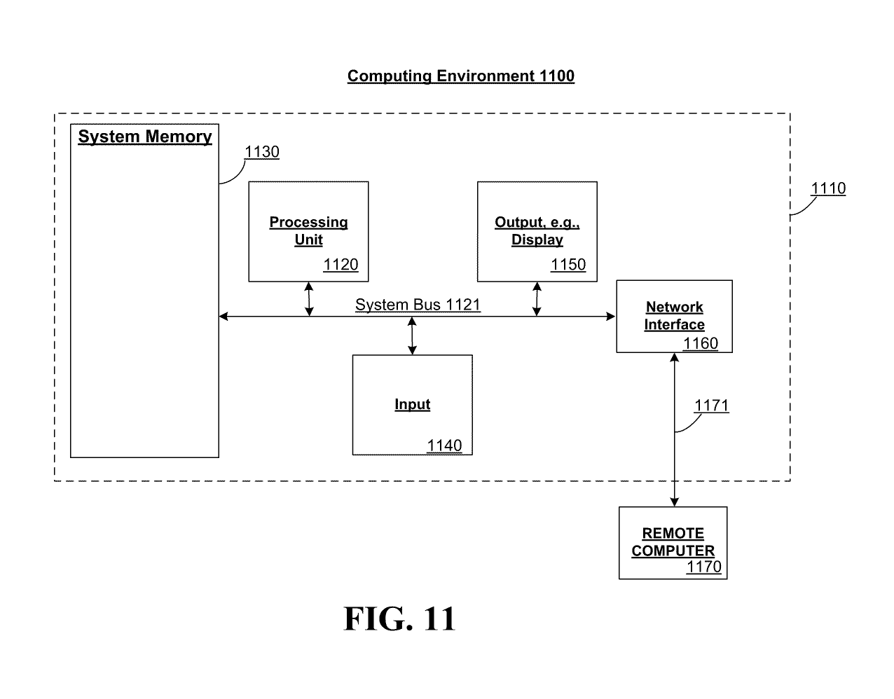

As mentioned, various embodiments described herein apply to any device wherein it may be desirable to implement one or pieces of a framework for augmenting reality via a secondary channel. It should be understood, therefore, that handheld, portable and other computing devices and computing objects of all kinds are contemplated for use in connection with the various embodiments described herein, i.e., anywhere that a device may provide some functionality in connection with a framework for augmenting reality via a secondary channel. Accordingly, the below general purpose remote computer described below in FIG. 11 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer-executable instructions, such as program modules, being executed by one or more computers, such as client workstations, servers or other devices. Those skilled in the art will appreciate that network interactions may be practiced with a variety of computer system configurations and protocols.

FIG. 11 thus illustrates an example of a suitable computing system environment 1100 in which one or more of the embodiments may be implemented, although as made clear above, the computing system environment 1100 is only one example of a suitable computing environment and is not intended to suggest any limitation as to the scope of use or functionality of any of the embodiments. Neither should the computing environment 1100 be interpreted as having any dependency or requirement relating to any one or combination of components illustrated in the exemplary operating environment 1100.

With reference to FIG. 11, an exemplary remote device for implementing one or more embodiments herein can include a general purpose computing device in the form of a handheld computer 1110. Components of handheld computer 1110 may include, but are not limited to, a processing unit 1120, a system memory 1130, and a system bus 1121 that couples various system components including the system memory to the processing unit 1120.

Computer 1110 typically includes a variety of computer readable media and can be any available media that can be accessed by computer 1110. The system memory 1130 may include computer storage media in the form of volatile and/or nonvolatile memory such as read only memory (ROM) and/or random access memory (RAM). By way of example, and not limitation, memory 1130 may also include an operating system, application programs, other program modules, and program data.

A user may enter commands and information into the computer 1110 through input devices 1140 A monitor or other type of display device is also connected to the system bus 1121 via an interface, such as output interface 1150. In addition to a monitor, computers may also include other peripheral output devices such as speakers and a printer, which may be connected through output interface 1150.

The computer 1110 may operate in a networked or distributed environment using logical connections to one or more other remote computers, such as remote computer 1170. The remote computer 1170 may be a personal computer, a server, a router, a network PC, a peer device or other common network node, or any other remote media consumption or transmission device, and may include any or all of the elements described above relative to the computer 1110. The logical connections depicted in FIG. 11 include a network 1171, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to augment reality via a secondary channel.

There are multiple ways of implementing one or more of the embodiments described herein, e.g., an appropriate API, tool kit, driver code, operating system, control, standalone or downloadable software object, etc. which enables applications and services to use a framework for augmenting reality via a secondary channel. Embodiments may be contemplated from the standpoint of an API (or other software object), as well as from a software or hardware object that provides pointing platform services in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of the various Figs. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various Figs., it is to be understood that other similar embodiments may be used or modifications and additions may be made to the described embodiment for performing the same function without deviating therefrom. Still further, one or more aspects of the above described embodiments may be implemented in or across a plurality of processing chips or devices, and storage may similarly be affected across a plurality of devices. Therefore, the present invention should not be limited to any single embodiment, but rather should be construed in breadth and scope in accordance with the appended claims.

What is claimed is:

1. A computer-implemented method, comprising:
employing a processor executing computer-readable instructions that, when executed by the processor, cause the processor to perform:
communicating a portion of content over a primary channel;
communicating a portion of information corresponding to the portion of the content, wherein the communicating the portion of the information is over a secondary channel, wherein the portion of the information is synchronized with the portion of the content, wherein the portion of information is distinct from and not embedded within or defined by the portion of the content over the primary channel; and
displaying the portion of the content and the portion of the information in a synchronized manner, wherein the displaying in the synchronized manner comprises displaying the portion of the content and the portion of the information such that the portion of the content and the portion of the information have spatial correspondence with one another.

2. The computer-implemented method of claim 1, wherein the portion of the content is a product being displayed on a television show.

3. The computer-implemented method of claim 2, wherein the portion of the information is product placement data for the product.

4. The computer-implemented method of claim 1, wherein the portion of the information is customized based, at least, on a demographic of a consumer to which the portion of the content is displayed or a preference of a consumer to which the portion of the content is displayed.

5. The computer-implemented method of claim 1, wherein the primary channel is independent of the secondary channel.

6. The computer-implemented method of claim 1, wherein the portion of content is communicated within content, and wherein the content is at least one of a film, television program, video, photo, video game, or website.

7. The computer-implemented method of claim 1, wherein the displaying is performed based, at least, on receiving a control signal initiated manually by a consumer to which the portion of the content is being displayed.

8. A computer-implemented system, comprising:
at least one processor;
a primary channel configured to communicate a portion of content;
a secondary channel configured to communicate a portion of information corresponding to the content, wherein the portion of information is distinct from and not embedded within or defined by the portion of content;
at least one synchronization module configured to synchronize the portion of the content with the portion of the information;
a display control module configured to control a display the portion of the content and the portion of the information in a synchronized manner controlled by the synchronization module; and
a computer-readable storage medium storing computer-executable instructions that, when executed, cause the at least one processor to perform one or more functions of the primary channel, the secondary channel, the at least one synchronization module or the display control module.

9. The computer-implemented system of claim 8, wherein the portion of the content is at least one of a product or business, the portion of the content being comprised within content, and the content being at least one of a film, television program, video, photo, video game, or website.

10. The computer-implemented system of claim 9, wherein the content is live or pre-recorded.

11. The computer-implemented system of claim 9, wherein the portion of the information is product placement data.

12. The computer-implemented system of claim 8, wherein the portion of the information is customized information based, at least, on a demographic of a consumer or on a preference of a consumer.

13. The computer-implemented system of claim 8, wherein the primary channel is independent of the secondary channel.

14. The computer-implemented system of claim 8, wherein the portion of the content is data associated with a social networking website and the portion of the information is a comment or advertisement regarding the portion of the content.

15. The computer-implemented system of claim 14, wherein the comment or the advertisement is provided to or from at least one of members of a social network.

16. The computer-implemented system of claim 15, wherein the primary channel is further configured to provide the data associated with the social networking website to the members of the social network.

17. A computer-implemented method, comprising:
employing a processor executing computer-readable instructions that, when executed by the processor, cause the processor to perform:
communicating a portion of content over a primary channel;
communicating a portion of information corresponding to the portion of the content, wherein the communicating the portion of the information is over a secondary channel, and wherein the portion of the information is synchronized with the portion of the content, wherein the portion of information is distinct from and not embedded within or defined by the portion of the content over the primary channel; and
displaying the portion of the content and the portion of the information in a synchronized manner, wherein the displaying in the synchronized manner comprises displaying the portion of the content and the portion of the information such that the portion of the content and the portion of the information have temporal correspondence with one another.

18. The computer-implemented method of claim 17, wherein the portion of the content is a product being displayed on a television show or is communicated within content, and wherein the content is at least one of a film, television program, video, photo, video game, or website.

19. The computer-implemented method of claim 17, wherein the portion of the information is customized based, at least, on a demographic of a consumer to which the portion of the content is displayed.

20. The computer-implemented method of claim 17, wherein the primary channel is independent of the secondary channel.
